(19) United States
(12) Patent Application Publication
(10) Pub. No.: US 2013/0238307 A1
(43) Pub. Date: Sep. 12, 2013

(54) DETERMINATION OF OPTIMIZATION POTENTIALS OF A DIRECT CURRENT MOTOR

(71) Applicants: Christian Hecker, Eppingen (DE); Christian Andreas Wolf Pozzo, Mohrendorf (DE)

(72) Inventors: Christian Hecker, Eppingen (DE); Christian Andreas Wolf Pozzo, Mohrendorf (DE)

(21) Appl. No.: 13/822,168

(22) PCT Filed: Sep. 1, 2011
(86) PCT No.: PCT/EP2011/065092

§ 371 Date: May 20, 2013

(30) Foreign Application Priority Data
Sep. 10, 2010 (DE) 10 2010 040 590.6

(51) Int. Cl. G06F 17/50

(52) U.S. Cl. CPC G06F 17/5009
USPC 703/13

(57) ABSTRACT

A method and computer program product are disclosed for determining at least one optimization potential of a direct current motor. In order to determine optimization potentials in a simple manner based on a rewinding of a direct current motor, an improvement in the energy efficiency of the motor due to a rewinding of the armature is assumed as a basis for the at least one optimization potential, and a thermal model of the rotor is created at least from design data of the motor, wherein at least one temperature curve is modeled by at least one load profile, and wherein the at least one optimization potential is determined from said temperature profile and from motor data from before and after the rewinding.

### CROSS-REFERENCE TO RELATED APPLICATIONS

This application is a U.S. National Stage Application of International Application No. PCT/EP2011/065092 filed Sep. 1, 2011, which designates the United States of America, and claims priority to DE Patent Application No. 10 2010 040 590.6 filed Sep. 10, 2010 The contents of which are hereby incorporated by reference in their entirety.

### TECHNICAL FIELD

The disclosure relates to a method for determining at least one optimization potential of a direct current motor and to a corresponding program and computer program product.

### BACKGROUND

Methods for determining an optimization potential of a direct current motor may be used, in particular, for the overhaul and/or repair of direct current motors. In many instances a rewinding of the armature of the direct current motor is herewith implemented, to which end the rewinding of the armature is usually recalculated and new insulation materials are also used. In such cases possible optimization potentials are not easy to determine and may therefore often not be disclosed to a customer.

The direct current motor is therefore hitherto often overhauled and rewound, and the customer allows the motor to run in the same way as before the rewinding, without utilizing the additional benefit of this rewinding.

Rewindings in motors, in which improvements in efficiency can also be made, have essentially been known for a while, see e.g. “The Effect of Repair/Rewinding on Motor Efficiency”, EASA/AEMT, 2003 (http://www.easa.com/sites/default/files/rwstdy1203.pdf, Feb. 21, 2013) and “Electrical Energy Equipment: Electric Motors”, UNEP, 2006

(http://www.energyefficiencyasia.org/docs/ee modules/Chapter-Electric%20Motors.pdf, Feb. 21, 2013), wherein an indicator is also specified in the latter document with which the influence of the rewinding on the motor efficiency can subsequently be determined.

### SUMMARY

One embodiment provides a method for determining at least one optimization potential of a direct current motor, which comprises at least one armature and one rotor, wherein an improvement in an energy efficiency of the motor by a rewinding of the armature is assumed as the basis of the at least one optimization potential, wherein a thermal model of the rotor is created at least from construction data of the motor, wherein at least one temperature curve is modeled by at least one load profile and wherein the at least one optimization potential is determined herefrom and from motor data from before and after the rewinding.

Another embodiment provides a program stored in non-transitory computer-readable media and executable by a processor for implementing such a method. Another embodiment provides a computer program product having such a program. In a further embodiment, the program is based on Microsoft Excel and the thermal model can be implemented by means of “Visual Basic for Applications”.

### BRIEF DESCRIPTION OF THE DRAWINGS

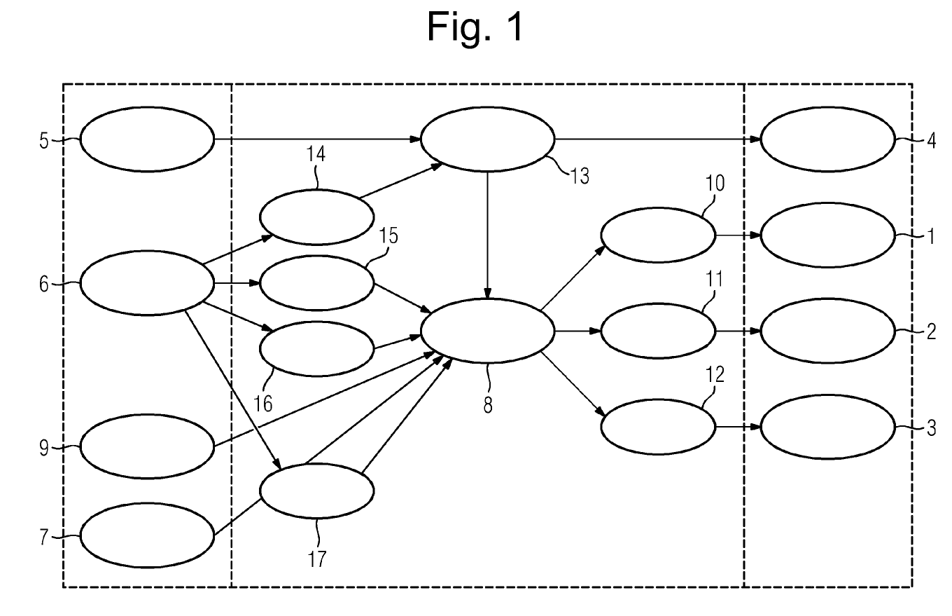

An exemplary embodiment is explained in more detail below with respect to FIG. 1, which shows a schematic representation for determining optimization potentials, which can be produced by a rewinding of an armature of a direct current motor with an improved energy efficiency.

### DETAILED DESCRIPTION

Embodiments of the present disclosure may determine and utilize optimization potentials resulting from rewinding of a direct current motor in a simple manner.

For example, one embodiment provides a method for determining at least one optimization potential of a direct current motor, which has at least one armature and one rotor, wherein an improvement in an energy efficiency of the motor by a rewinding of the armature is assumed as the basis of the at least one optimization potential, wherein a thermal model of the rotor is created at least from construction data of the motor, wherein at least one temperature curve is modeled by at least one load profile and wherein the at least one optimization potential is determined herefrom and from motor data from before and after the rewinding.

Other embodiments provide a program stored in non-transitory computer-readable media and executable by a processor for implementing such a method, and a computer program product including such a program.

In order to determine the optimization potentials, the disclosed method is based on an improvement in the energy efficiency of the motor as a result of the rewinding of the armature. This can be determined for an actually rewound motor, wherein the individual partial losses before the rewinding of the machine are determined for instance from the nameplate and the test certificate. Subsequently the change in power loss, the armature supply voltage and/or the degree of efficiency is then calculated for example with the armature resistance after the rewinding. Different improvements in efficiency can naturally also be offered to the customer (at different costs for instance with/without new insulation materials) and the optimization potentials determined for said improvements in each case.

A thermal model of the rotor is created from the existing construction data. The different temperature curves are herewith modeled for different load profiles (or also load cycles, the term used to refer a period of recurring load curves) of the motor. A temperature curve 12 for an unchanged load profile of a customer can be calculated for instance, for which an optimization potential is determined for a lengthening of the service life. A temperature curve with a shortening of the cooling phases, which is possible by the increase in efficiency, can also be modeled, wherein an increase in availability is determined as an optimization potential. A further modeled temperature curve may relate to a regulation of the fan, for instance, from which a saving of fan output is produced, the optimization potential of which is determined. The determined optimization potentials can be visualized for instance with the aid of diagrams.

Different optimization potentials can be determined by the disclosed method by the rewinding of the armature. This enables the customer to be issued with a certificate of performance, for example relating to the new capacities of his/her motor in respect of motor efficiency, increase in availability, service life lengthening and/or saving in terms of fan output.

In one embodiment, the program for implementing the method is developed as an optimization tool based on Microsoft Excel and the thermal model is implemented in the Excel tool by means of Visual Basic for Applications” (VBA).

FIG 1 shows a schematic representation of the disclosed method for determining optimization potentials 1-3, which can be produced by a rewinding of an armature of a direct current motor on account of an improved energy efficiency 4. The dashed lines show three areas, of which the left stands for the input for the calculation, the middle for the calculation itself and the right for the output, in other words the optimizations.

Therefore motor data such as the armature resistance before the rewinding 14, (partial) losses of the direct current motor 15, thermal capacitance and/or thermal resistance before and after the rewinding 16 as well as the flow cross-section and/or the rotor surface 17 can result from documentation 6 such as the test certificate, data sheet and/or engineering specifications of the direct current motor. In such cases data relating to the ventilation and/or if necessary the ambient temperature 7 is also included in the flow cross-section and/or the rotor surface 17. The armature resistance after the rewinding 13 can be determined from the data of the copper conductor before and after the rewinding 5, and the improvement in the energy efficiency 4 is determined together with the armature resistance before the rewinding 14.

The thermal model 8 (temperature model), including inter alia the motor data 13-17, is created from the construction data 5-7. With this, different temperature curves 10-12 can now be modeled for different load profiles such as for instance an existing load profile of a customer 9. The different temperature curves 10-12 herewith indicate different optimization potentials 1-3. The temperature curve 10 here stands for a use of the motor with an unchanged load profile 9 before and after the rewinding, which, as a result of the increased energy efficiency and the lower stress on the motor resulting therefrom, produces a lengthening of the service life 1 as an optimization. For a temperature curve 11 which, on account of less heat being developed, provides for a use of the motor with a shortening of the cooling phase, the increase in availability 2 can be determined as an optimization potential. Instead, even with constant cooling phases, a temperature curve 12 with a changed regulation of the fan can also be modeled, as a result of which a saving of fan output 3 is determined as an optimization potential. Naturally hybrid forms can be modeled in addition to these “pure” modelings, for which for instance a slight lengthening of the service life 1 is produced with a slight increase in availability 2 with a slight saving on the fan output 3.

The calculation of the “pure” optimization potentials 1-3 may be advantageous in that a graphical representation of the results can be easily visualized to a customer for instance, this being possible with his/her motor after the rewinding in the case of a corresponding “mode of operation”. This can also be issued to the customer in the form of a performance certificate relating to the new properties of his/her motor in respect of motor efficiency 4, increase in availability 2, lengthening of the service life 1 and saving in terms of the fan output 3.

In summary, the disclose provides a method for determining at least one optimization potential of a direct current motor and to a corresponding program and computer program product. In order to determine optimization potentials in a simple manner as a result of a rewinding of a direct current motor, a method is proposed, wherein an improvement in an energy efficiency of the motor by a rewinding of the armature is assumed as the basis of the at least one optimization potential, wherein a thermal model of the rotor is created at least from construction data of the motor, wherein at least one temperature curve is modeled by at least one load profile and wherein the at least one optimization potential is determined herefrom and from motor data from before and after the rewinding.

What is claimed is:

1. A computer-implemented method for determining at least one optimization potential of a direct current motor having at least one armature and one rotor, wherein an improvement in an energy efficiency of the motor by a rewinding of the armature is assumed as the basis of the at least one optimization potential, the method comprising:
using a processor to generate a thermal model of the rotor at least from construction data of the motor, including:
modeling at least one temperature curve corresponding with at least one load profile, and
determining the at least one optimization potential based on the at least one temperature curve and motor data from before and after the rewinding.

2. A computer program product for determining at least one optimization potential of a direct current motor having at least one armature and one rotor, wherein an improvement in an energy efficiency of the motor by a rewinding of the armature is assumed as the basis of the at least one optimization potential, the computer program product comprising computer instructions stored in non-transitory computer-readable media and executable by a processor to:
generate a thermal model of the rotor at least from construction data of the motor, including:
modeling at least one temperature curve corresponding with at least one load profile, and
determining the at least one optimization potential based on the at least one temperature curve and motor data from before and after the rewinding.

3. The computer program product of claim 2, wherein the program is based on Microsoft Excel and the thermal model is implementable with “Visual Basic for Applications”.

4. (canceled)
